(19) United States
(12) Patent Application Publication
(10) Pub. No.: US 2006/0217876 A1
(43) Pub. Date: Sep. 28, 2006

(54) System and method for assigning plurality of locations to individuals and routing individuals to locations

(75) Inventors: Raphael Houri, Rancho Santa Fe, CA (US); Steven Michael Preddy, San Diego, CA (US)

Correspondence Address: AKIN GUMP STRAUSS HAUER & FELD, LLP, P O BOX 688, DALLAS, TX, 75313-0688, US

(73) Assignee: Washington Inventory Service

(21) Appl. No.: 11/090,084

(22) Filed: Mar. 25, 2005

(51) Int. Cl. G01C 21/34

(52) U.S. Cl. 701/202; 701/209; 340/995.19

(57) ABSTRACT

A system and method for assigning a plurality of locations to individuals and for creating work schedules and routes for the individuals is disclosed. In one aspect of the invention, location data including a list of locations and location addresses is received. The location coordinates are determined from the location addresses. Next, individual data including addresses of the individuals is received, and individual coordinates are determined from the individual addresses. Next, the distances between the individual coordinates and location coordinates are determined, and the locations are assigned to the individuals based on the distances, the individual data and other predetermined criteria.

### TECHNICAL FIELD

This invention relates to assigning a plurality of locations to individuals and routing the individuals to the locations. More specifically, the invention relates to a method and system for assigning a plurality of locations to the individuals and routing the individuals to the locations based on an individual's distance relative to the locations, the individual's available time and qualification.

### BACKGROUND OF THE INVENTION

Many businesses regularly send workers to work at different off-site locations (i.e., job-sites). For example, a business such as a service provider may provide inventory and merchandise management services to retail stores. The retail stores may contract with the service provider to collect and consolidate their inventory data and manage their merchandise. Since the service provider typically serves many stores, the service provider needs to assign its workers to the stores. The service provider needs to ensure that the workers are assigned to the stores in a manner so the stores are serviced according to a schedule and that projects are completed by due dates.

In assigning the stores to the workers, the service provider needs to consider several factors. The service provider needs to consider the time an individual worker has available to perform the job. The service provider also needs to consider the workers' locations relative to the stores, the time required by the workers to travel to and from the stores, and the workers' qualifications. The service provider preferably needs to assign the stores in a manner that minimizes travel time or distance. Thus, the service provider needs to use its resources, i.e., the workers, efficiently in order to serve the stores.

If a service provider only serves ten stores and employs five employees, the service provider may be able to easily assign the employees to the stores. The service provider can manually assign the ten employees to the five stores based on the employees' proximity to the stores and allow the employees to follow reasonable routes.

However, if the service provider must serve hundreds or perhaps thousands of stores and employ hundreds or thousands of employees, assigning the stores among the employees can be a difficult task. In such as scenario where the service provider serves thousands of stores and employs thousands of employees, it is not possible to manually assign the employees to the stores and creates routes for the employees in order to serve the assigned stores.

Accordingly there is a need for a method and system that provides automated assignment of workers to a plurality of job-sites based on the workers' availability, locations relative to the job-sites and qualifications, and creates routes to the job-sites.

### SUMMARY OF THE INVENTION

The present invention is directed to a system and method for assigning a plurality of locations to individuals and for creating work schedules and routes for the individuals. In one aspect of the invention, location data including a list of locations and location addresses is received. The location coordinates are determined from the location addresses. Next, individual data including addresses of the individuals is received, and individual coordinates are determined from the individual addresses. Next, the distances between the individual coordinates and location coordinates are determined, and the locations are assigned to the individuals based on the distances. In one aspect, information regarding individuals' qualifications to perform the required tasks is received and is considered during the assignment of locations. Next, work schedules of the individuals are created, the work schedule providing the number of assigned locations to visit on a day, in a week, in a month or in any period of time. Next, routes providing the order in which the individuals should visit the locations are created. The routes are created based on the distances and the time required to travel the distances.

### BRIEF DESCRIPTION OF THE DRAWINGS

FIG. 1 is a flow diagram of the method steps for assigning workers to a plurality of stores and for creating routes to the stores in accordance with one embodiment of the invention.

FIG. 2 is a flow diagram illustrating in more detail the steps of assigning a plurality of stores to the employees.

FIG. 3 is a flow diagram illustrating in more detail the steps of creating routes for the employees.

FIGS. 4A-4C illustrate the results of the steps described in the flow diagram of FIG. 3.

FIG. 5 is a flow diagram of the steps of an alternate method of creating routes for the employees.

FIG. 6 is a functional block diagram of a computer system 600 configured to run a software application in accordance with one embodiment of the invention.

FIGS. 7A-7C illustrate steps of an alternate method for assigning locations to individuals and creating routes for the individuals.

### DETAILED DESCRIPTION OF PREFERRED EMBODIMENTS

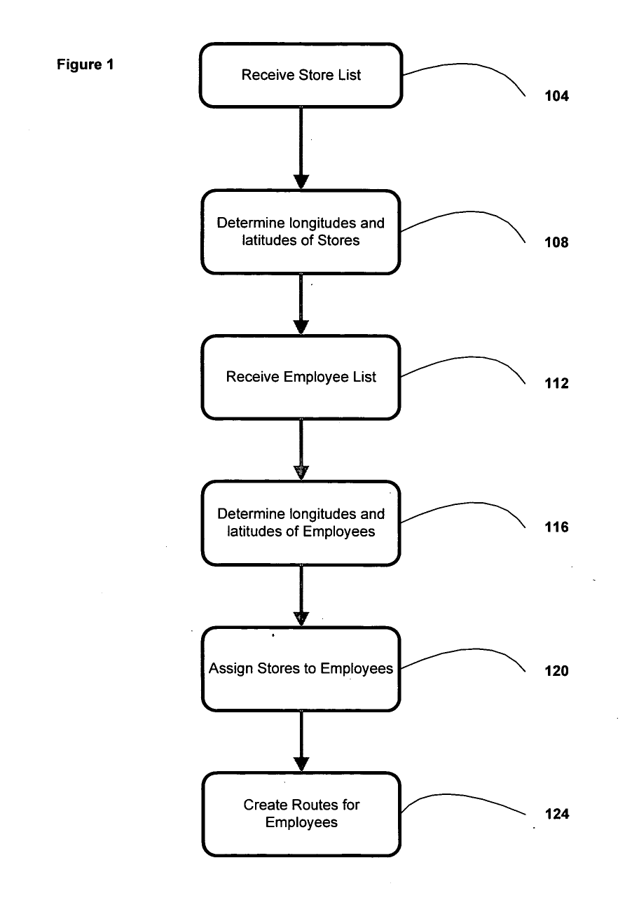

FIG. 1 is a flow diagram of the method steps for assigning workers to a plurality of stores and for creating routes to the stores in accordance with one embodiment of the invention. In the following description, the terms “workers”, “individuals” and “employees” are used interchangeably, and “locations”, “stores”, and “job-sites” are used interchangeably.

In step 104, a store list having various information about the stores is received. The store list may be a database that includes store related information such as, for example, store addresses. In one embodiment, a work order may also be received, wherein the work order specifies various tasks to be performed at the stores and also provides specific dates and times when the stores may be serviced by the employees.

In step 108, coordinates (i.e., longitudes and latitudes) of the stores are determined from the store addresses. The longitude and latitude of an address can be obtained using any one of several well known methods.

In step 112, an employee list providing various information about the employees of the service provider are received. The employee list may be a database that includes various employee related information such as, for example, names and addresses of the employees. The employee list also includes each employee's work availability such as the dates and times the employee is available to work. The employee list may also indicate the maximum amount of time the employee can work on a day, in a week, in a month or in any other time period. In one embodiment, the list may include employee attributes such as, for example, the amount of weight an employee can lift (e.g., 50 lbs.), language skills (e.g., ability to speak Spanish), or whether the employee has a truck.

In step 116, coordinates (i.e., longitudes and latitudes) corresponding to the employee addresses are determined. An employee address can be a residence address, the address of the employer (i.e., the service provider) or any other designated address.

In step 120, the stores are assigned to the employees based on each employee's distance from a store and the employee's capacity. In one embodiment, the employee's capacity may be defined as a percentage of the employee's unfilled time in comparison to the employee total available time. The employee's capacity may be defined in other ways as will be obvious to those skilled in the art.

In one embodiment, the dates and times the employee is available to work and the maximum amount of time the employee can work is also considered. Also, in one embodiment, if a work order provides that a specific store can be serviced only on certain dates and/or at certain times, only employees that are available on those dates and times are considered for that store. If the job requires two or more employees, then employees that qualify based on their availability are assigned to the task.

In one embodiment of the invention, the employee list identifies employees who are qualified to perform certain types of work. If the store requires that only employees qualified to perform certain types of work be sent to the stores, then only qualified employees are assigned to the stores. Thus, employee qualifications are matched with the requirements specified by the stores to assign appropriate employees to the stores.

In step 124 the stores assigned to individual employees are identified and routes are created to allow the employees to travel to the stores. In one embodiment of the invention, the routes are created based on the distance between an employee and the store and the maximum amount of time the employee can work on a day, in week, in a month, or in any other time period.

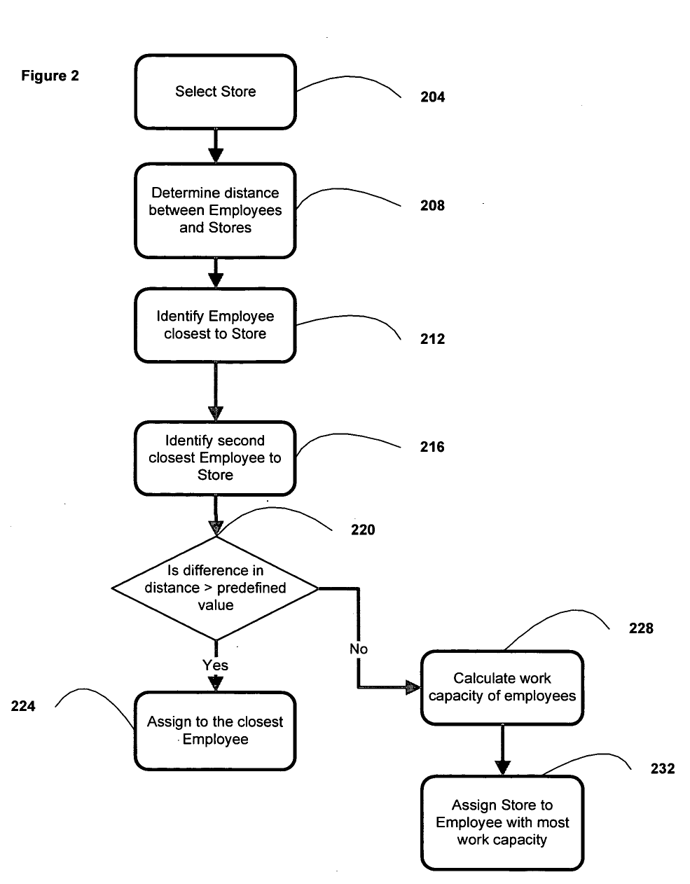

FIG. 2 is a flow diagram illustrating in more detail step 120 shown in FIG. 1 (i.e., assigning a plurality of stores to the employees). In step 204, a particular store is selected for assignment. In step 208 distances between the store and the employees are determined from the coordinates of the store and the coordinates of the employees. In step 212, for the particular store, the closest employee to the particular store is identified, the closest employee being the employee located at the shortest distance from the particular store. In step 216, the second closest employee to the store is identified, the second closest employee being the employee located at the second shortest distance from the particular store.

In step 220, the distance between the closest employee and the store and the distance between the second closest employee and the store are compared. If the difference between the two distances is greater than a predetermined value, the closest employee to the store is assigned to the store in step 224. In one embodiment of the invention, if the difference is greater than 20%, the closest employee is assigned to the store.

If the difference is not greater than the predetermined value, the flow moves to step 228 where the two closest employees' percentage of original work availability is calculated. The percentage of original work availability indicates what percentage of original work availability is still remaining after taking in account the stores already assigned to the employees. In one embodiment, the percentage of original work availability is defined as a ratio of an employee's total work availability to the employee's work availability already used. As will be appreciated, the foregoing definition of work availability provides load balancing and fairness among employees. As will be appreciated by those skilled in the art, the term “work availability” may also be defined in various other ways and may be used to assign the store to the employees.

In step 232, the store is assigned to the employee that has the higher percentage of original work availability. Thus, when two employees are located within relatively same distance (i.e., less than a predetermined value) from a specific store, the employee that has a higher percentage of the original work availability is assigned to the store. By assigning the store to the employee with the higher percentage of the original work availability, an employer can ensure that all workers are given a fair opportunity to work.

In one embodiment, in the foregoing steps 224-228, if the difference in distances are close (e.g., less than 20%), an alternate method is utilized to assign the store to the employee. First, the geographical center of the stores already assigned to each of the two employees are calculated by averaging the latitudes and longitudes of the stores. Next the distance between the new store (i.e., the store that needs to be assigned) to the centers are calculated, and the new store is assigned to the employee that has the closest center to the new store.

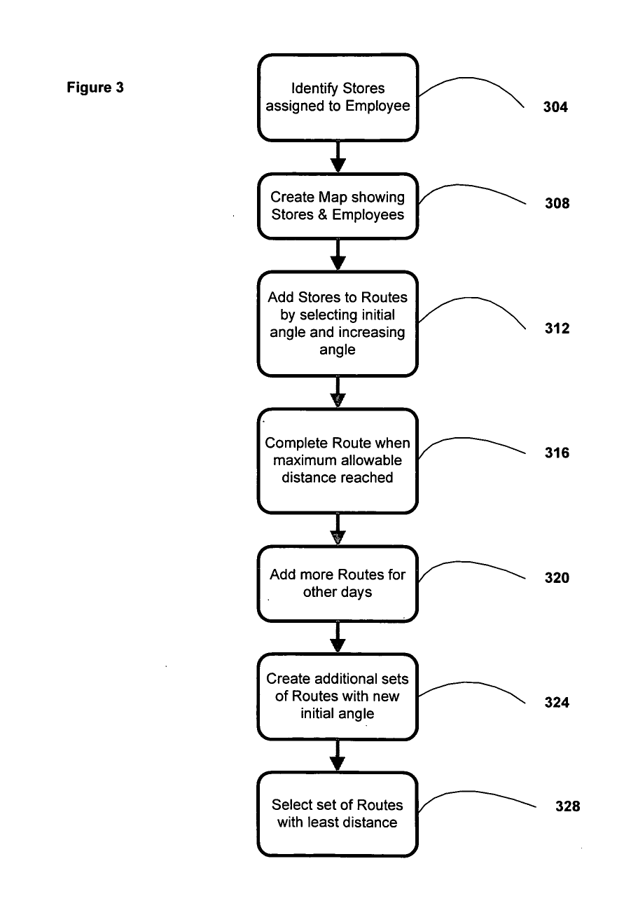

After the stores are assigned to the employees, a route is created for each employee providing the path the employee will follow to serve the assigned stores. FIG. 3 is a flow diagram illustrating in more detail step 124 (i.e., step for creating routes for the employees) of FIG. 1. In step 304, stores assigned to a particular employee are identified. In step 308, a map identifying the coordinates of the assigned stores and the coordinates of the employee is created.

In step 312, an initial angle (e.g., 0 degree) is selected, and centered at the employee coordinate, the angle is incremented beginning at the initial angle to locate and identify a store on the map. The first store located by the increasing angle is connected to the center or origin (i.e., employee's coordinates) by a line. The angle is continually increased to locate and add more stores. As each store is located by increasing the angle, that store is added to the route and the optimal path is re-calculated (i.e., route is re-calculated).

As more stores are added to the route, the total distance the employee must cover increases. If the total distance reaches the maximum distance an employee is allowed to travel in a day, in step 316 the route is completed for a particular day by connecting the last (i.e., most recent) job-site to the employee's coordinate, and no further stores are added to the route for that day. In one embodiment, the total amount of time required to commute to the job-sites and to complete the work at the job-sites is also calculated as stores are added, the total sequence order is evaluated and the shortest path is selected

If the total amount of time exceeds the maximum time an employee is allowed to work in a day, the route is completed for that day. Thus a route for a day is completed when either the maximum allowable distance or the maximum allowable time for a day is reached, or there are no more stores to assign.

In step 320, the foregoing steps are repeated to create routes for other days by incrementing the angle and adding stores to the route. As stores are added to the route, the total distance covered and the total amount of time required to commute and to work is calculated, and the route is completed when either the maximum daily allowable distance or the maximum daily allowable time is reached, or there are no more stores to assign. The maximum daily allowable distance or the maximum daily allowable time can be specified by the employer (i.e., service provider) or the employee. When all the stores have been added to the routes, the set of routes corresponding to the selected initial angle is completed.

In step 324, the foregoing process is repeated with a new initial angle, and a new set of routes is created. The new initial angle is created by incrementing the previous initial angle. Thus, for each initial angle, a set of routes is created, and a plurality of sets of routes are created corresponding to a plurality of initial angles. In step 328, the total distance associated with each set of routes is calculated, and the set of routes having the least total distance is selected.

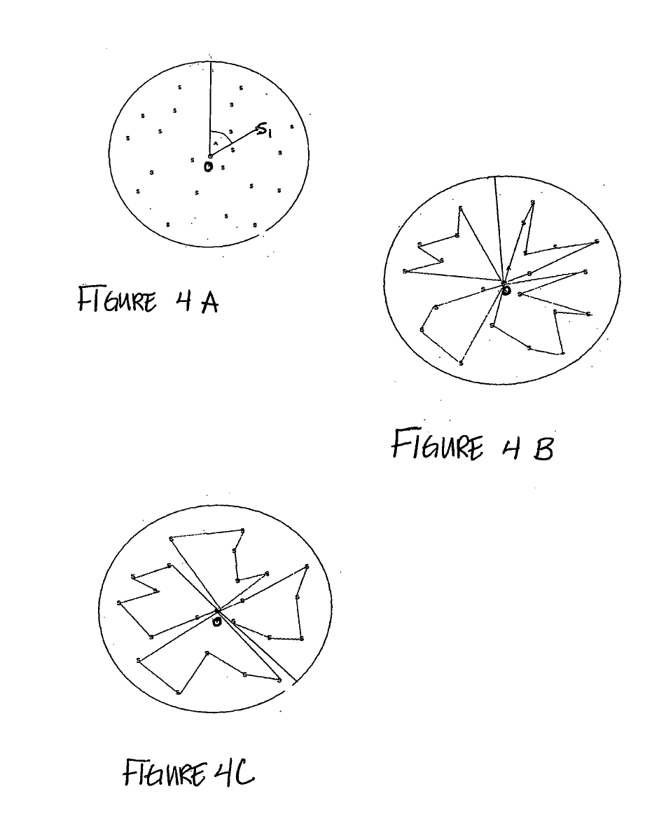

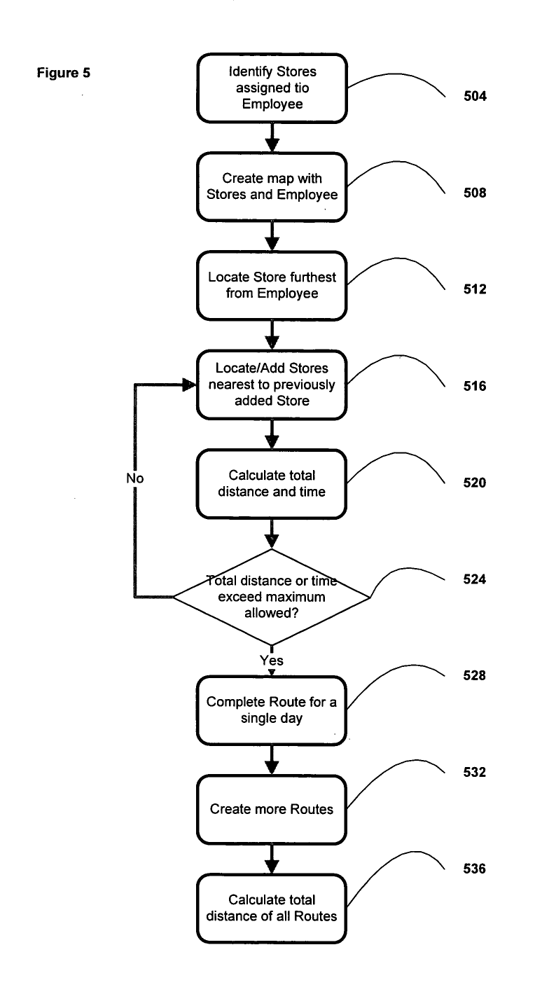

FIGS. 4a-4c illustrate the results of the steps described in the flow diagram of FIG. 3. FIG. 4a shows a map indicating the stores' coordinates (indicated by S) and the employee coordinates (also referred to as center or origin). An initial angle is selected and centered at the origin the angle is incremented until the first store is located (designated by S1) on the map. The store S1 is located at an angle A relative to the initial angle. FIG. 4b shows a first set of routes that include the stores assigned to the employee. FIG. 4c shows a second set of routes created with a new initial angle. As discussed before, the initial angle is incremented and a set of routes are created corresponding to the initial angle. The total distance associated with each set of routes is calculated, and the set of routes having the shortest total distance is selected.

FIG. 5 is a flow diagram of the steps of an alternate method of creating routes for the employees. In one embodiment, the alternate method is used to determine the route and the route is compared to other routes created using other methods (e.g., the foregoing method), and the best solution (e.g., the route having the shortest total distance) is selected. In step 504, the stores assigned to a particular employee are identified. In step 508, a map identifying the coordinates of the stores assigned to the employee and the coordinates of the employee is created. In step 512, the store located farthest from the employee coordinates is identified and the store (the “first store”) is connected to the employee coordinates by a line. In step 516, the closest store to the first store is identified and the store (the “second store”) is added to the route by calculating the optimal path. The process is repeated by adding more stores to the route and re-calculating the path. In step 520, the total distance associated with the route and the time required to travel and work at the stores are calculated. In step 524, if the total distance or the total time exceeds the maximum daily allowable distance or time or there are no more stores to add, the route is completed for the day by connecting the last store to the employee coordinates. If the total distance or the total time do not exceed the maximum daily allowable distance or the maximum daily allowable time, the flow returns to step 516 where additional stores are added using the foregoing steps until the maximum distance or the maximum time is reached. The maximum daily allowable distance and the maximum daily allowable time can be specified by the service provider or the employee. In step 528, additional routes are created for subsequent days using the foregoing steps until all stores are assigned to the employee. In step 532, the total distance associated with all the set of routes is calculated. In one embodiment, the foregoing two methods as well as other methods for creating routes are utilized, and the method producing the best result (e.g., shortest total distance) is selected.

In one embodiment of the invention, the total distance associated with the set of routes in FIG. 3 is compared to the total distance associated with the set of routes in FIGS. 5. The set of routes that has the least total distance is selected and provided to the employee.

In one embodiment of the invention, changes and modifications can be made to an employee's route. For example, one or more stores can be manually added or removed from an employee's route. Also, one or more routes can be moved from one employee to another employee. If all stores are not assigned due to a lack of available employees, un-routed stores can be manually added to one or more employees. If an employee is sick or otherwise unavailable, his route can be reassigned to another employee. In one embodiment of the invention, un-routed stores are listed and can be used to create additional routes for employees willing to expand their available hours or days.

In one embodiment of the invention, the method steps for assigning a plurality of stores to employees and creating routes for the employees in accordance with the foregoing descriptions are executed by a software application having computer readable program code. The program code is embodied in a computer readable media (also referred to as a computer program product) such as a hard disk, a floppy disk, a compact disk read only memory (CD ROM) or any other computer readable media. The program code may be written in any computer programming language, such as, for example, C, C++, C#, Java, Basic, Cobol, Delphi, Pascal, Assembly Language, etc.

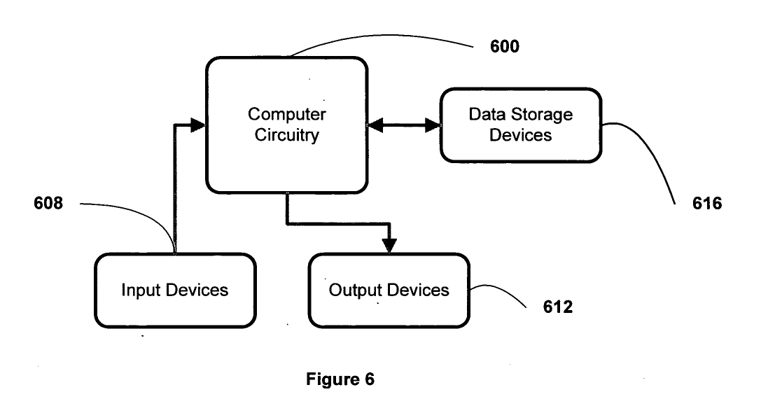

FIG. 6 is a functional block diagram of a computer system 600 configured to assign a plurality of stores to the employees in accordance with one embodiment of the invention. The computer system includes computer circuitry 604 for performing various computing functions, such as running a software application to assign a plurality of stores to the employees and create routes. The computer system 600 also includes one or more input devices 608, such as a keyboard or a mouse, coupled to the computer circuitry 604 to allow an operator to interface with the computer system 600. Typically the computer system 600 also includes one or more output devices 612 coupled to the computer circuitry 604, such output devices typically including a printer and a video terminal. One or more storage devices 616 are also typically coupled to the computer circuitry 604. Examples of typical storage devices 616 include hard drive, floppy disks, and compact disk read only memory (CD ROM). The program code of the software application may reside in the data storage devices 616 and may be accessed by the computer circuitry 604.

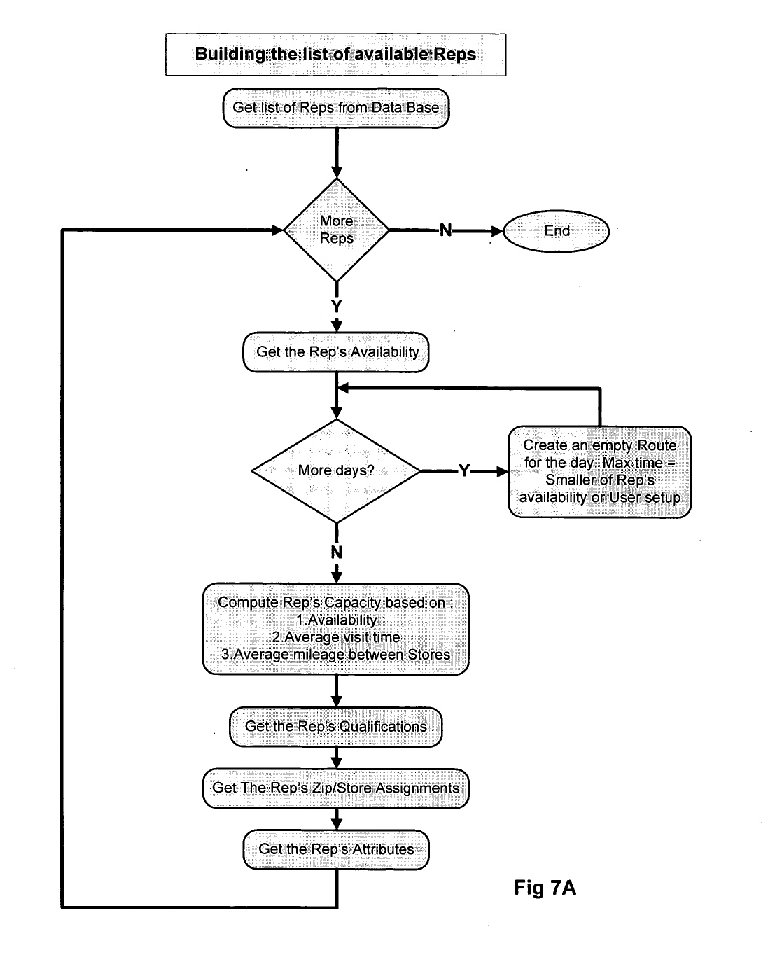

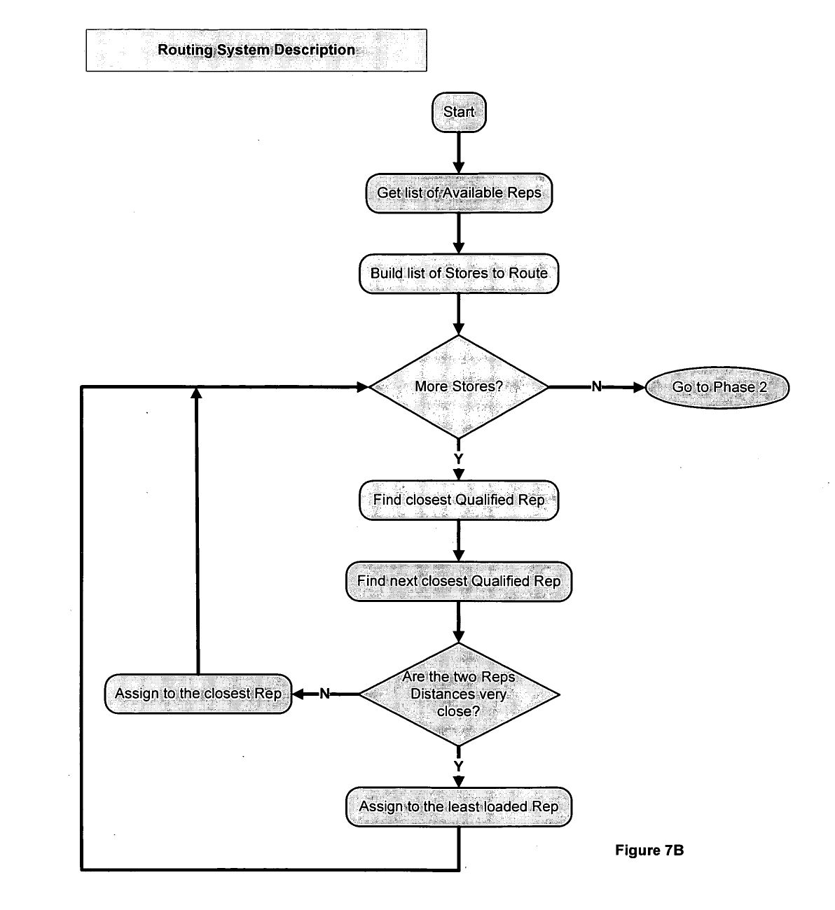

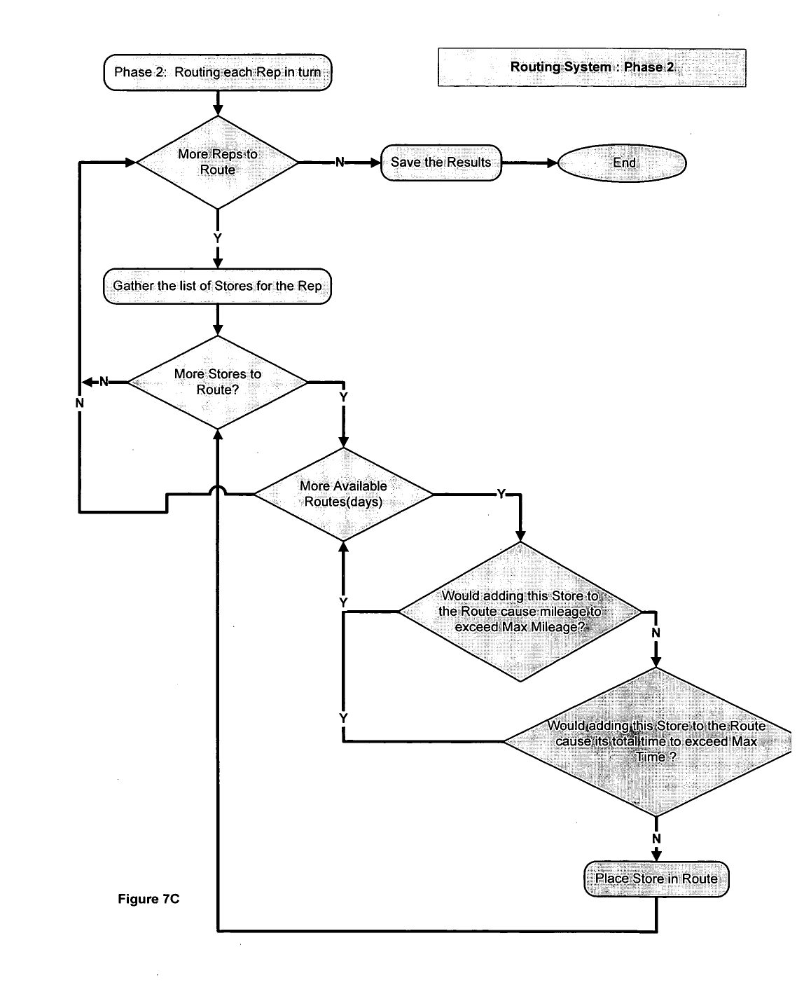

FIGS. 7A, 7B and 7C illustrate various other embodiments of the present invention. In FIGS. 7A, 7B and 7C, the term “Reps” imply “individuals” or “employees”, and the term “store” implies “job-sites” or “locations.” FIG. 7A provides method steps for creating a list of Reps or individuals or employees. The initial data may be obtained from a database. The Reps attributes may include abilities to speak foreign languages, ownership of a vehicle, etc. The method calculates the Rep's capacity based on availability, average visit time (to the locations or stores) and average mileage between locations or stores. FIGS. 7B and 7C illustrate method steps for assigning stores to the employees and routing the employees to the stores. In phase 1, the stores are assigned or allocated to the Reps, and in phase 2 routes are created for the employees.

Even though various embodiments and advantages of the present invention have been set forth in the foregoing description, the above disclosure is illustrative only, and changes may be made in detail and yet remain within the broad aspects of the invention. For example, although the specification refers to “employees”, “job-sites”, “stores” and “locations”, it will be understood that various embodiments of the invention are applicable to other types of businesses, locations and individuals. The present invention is to be limited only by the appended claims.

What is claimed is:

1. A method for assigning a plurality of locations to individuals and for creating schedules and routes to and from the locations, the individuals using the routes to travel to the locations, comprising:
receiving location data including a list of locations and location addresses;
determining the location coordinates from the location addresses;
receiving identity data including addresses of the individuals;
determining the individual coordinates from the individual addresses;
receiving workload data of the individuals, the workload data including the amount of time an individual is available to work;
determining distances between the individual coordinates and location coordinates;
assigning locations to the individuals based on the distances and the workload data;
determining the schedules of the individuals including the number of assigned locations to visit based on the distances and the workload data;
determining routes to and from the locations for the individuals based on the distances and the workload data.

2. The method of claim 1 wherein the step of assigning each location to the individuals further comprises:
identifying, for a particular location, the closest individual to the particular location, the closest individual being at the shortest distance from the particular location;
identifying, for the particular location, the next closest individual to the particular location, the next closest individual being at the next shortest distance from the particular location;
determining the difference in distance between the closest individual and the next closest individual with respect to the particular location;
if the difference in distance between the closest individual and the next closest individual is greater than a predetermined percentage, assigning the particular location to the closest individual;
if the difference in distance between the closest individual and the next closest individual is less than the predetermined percentage, not assigning the particular location.

3. The method of claim 2 further comprising allocating the un-assigned location by calculating the percentage of original work availability of the closest individual and the next closest individual, and assigning the location to the individual that has a higher percentage of original work availability.

4. The method of claim 3 wherein the step of determining routes for the individuals comprises:
creating a map displaying the coordinates of the locations assigned to a particular individual and the individual coordinates;
starting at a first angle, centered at the individual coordinate, incrementing the angle to locate and add locations to the route;
calculating total distance traveled originating from the individual coordinate as more locations are added to the route;
returning to the individual coordinates and completing the daily route when a maximum daily allowable travel distance is reached;
incrementing the angle to create additional daily routes for additional days until all locations are routed by a first set of routes, wherein the first set of routes has a plurality of daily routes.

5. The method of claim 4 further comprising incrementing the starting angle and repeating the steps of claim 4 to create a plurality of sets of routes, wherein each set of routes is generated using a different starting angle and wherein each set of routes has a plurality of daily routes.

6. The method of claim 5 further comprising calculating the total distance associated with each set of routes, and selecting the set of routes having the least total distance.

7. The method of claim 3 wherein the step of determining daily routes for the individuals further comprises:
creating a map displaying the coordinates of the locations assigned to a particular individual and the individual coordinates;
selecting the location farthest from the individual coordinates;
building a daily route by adding locations closest to the previously selected location;
calculating total distance traveled originating from the individual coordinate as more locations are added to the route;
returning to the individual coordinates and completing the daily route when a maximum daily allowable travel distance is reached or all locations are routed.

8. The method of claim 7 further comprising creating additional daily routes by repeating the steps of claim 7 until all locations are assigned.

9. The method of claim 7 further comprising calculating the total distance associated with the routes.

10. The method of claim 9 further comprising comparing the total distance associated with the routes in claim 9 to the total distance associated with the routes in claim 6 for each individual, and selecting the routes having a shorter total distance.

11. The method of claim 1 further comprising generating a report listing the assigned locations for the individual.

12. The method of claim 1 further comprising generating a report providing the routes for the individual.

13. The method of claim 12 wherein the report provides a daily work schedule for the individual.

14. The method of claim 12 wherein the report provides the number of locations the individual is required to visit each day.

15. The method of claim 1 further comprising determining the location coordinates by determining longitudes and latitudes of the locations.

16. The method of claim 1 further comprising determining the individual coordinates by determining longitudes and latitudes of the individual's addresses.

17. The method of claim 1 wherein the workload data includes the amount of time the individual is available to work during a day, a week, a month or in any time period.

18. The method of claim 1 wherein the location data is stored in a location database, the location database including the list of locations and longitudes and latitudes of the locations.

19. The method of claim 1 wherein the identity data and the workload data are stored in an individual database, the individual database including longitudes and latitudes of the individuals and the amount of time an individual is available to work.

20. The method of claim 1 further comprising adding new locations to the individual's assigned routes.

21. The method of claim 1 further comprising adding new routes to the individual's assigned routes.

22. The method of claim 1 further comprising removing one or more locations from the individual's assigned locations.

23. The method of claim 1 further comprising removing routes from the individual's assigned routes.

24. A computer system, comprising:
a data input device;
a data output device;
a processor coupled to the data input and output devices;
a memory device coupled to the processor;
a storage device coupled to the processor having computer readable program code embodied in the storage device for causing an application program to execute on the computer system method steps for assigning a plurality of locations to individuals and for creating work schedules and routes to and from the locations, the individuals using the routes to commute to the locations in order to perform tasks at the locations, comprising:
receiving location data including a list of locations and location addresses;
determining the location coordinates;
receiving identity data including addresses of the individuals;
determining the individual coordinates;
receiving workload data of the individuals, the workload data including the amount of time an individual is available to work;
determining distances between the individual coordinates and location coordinates;
assigning the locations to the individuals based on the distances and the workload data;
determining work schedules of the individuals including the number of assigned locations to visit based on the distances and the workload data;
determining routes to and from the locations for the individuals based on the distances and the workload data.

25. The computer system of claim 24 wherein the step of assigning a location to the individuals further comprises:
identifying, for a particular location, the closest individual to the particular location, the closest individual being at the shortest distance from the particular location;
identifying, for the particular location, the next closest individual to the particular location, the next closest individual being at the next shortest distance from the particular location;
determining the difference in distance between the closest individual and the next closest individual with respect to the particular location;
if the difference in distance between the closest individual and the next closest individual is greater than a predetermined percentage, assigning the particular location to the closest individual;
if the difference in distance between the closest individual and the next closest individual is less than the predetermined percentage, not assigning the particular location.

26. The computer system of claim 24 wherein the method steps further comprises allocating the un-assigned location by calculating the percentage of original work availability of the closest individual and the next closest individual, and assigning the location to the individual that has a higher percentage of original work availability.

27. The computer system of claim 26 wherein the step of determining routes for the individuals comprises:
creating a map displaying the coordinates of the locations assigned to a particular individual and the individual coordinates;
starting at a first angle, centered at the individual coordinate, incrementing the angle to locate and add locations to the route;
calculating total distance traveled originating from the individual coordinate as more locations are added to the route;
returning to the individual coordinates and completing the daily route when a maximum daily allowable travel distance;
incrementing the angle to create additional daily routes for other days until all locations are routed by a first set of routes, wherein the first set of routes has a plurality of daily routes.

28. The computer system of claim 27 wherein the step of determining routes for the individuals further comprises incrementing the starting angle and repeating the steps of claim 27 to create a plurality of sets of routes, wherein each set of routes is generated using a different starting angle and wherein each set of routes has a plurality of daily routes.

29. The computer system of claim 27 wherein determining routes for the individuals further comprises calculating the total distance associated with each set of routes, and selecting the set of routes having the least total distance.

30. The computer system claim 27 wherein the step of determining routes for the individuals further comprises:
creating a map displaying the coordinates of the locations assigned to a particular individual and the individual coordinates;
selecting the location farthest from the individual coordinates;
building a daily route by adding locations closest to the previously selected location;
calculating total distance traveled originating from the individual coordinate as more locations are added to the route;
returning to the individual coordinates and completing the daily route when a maximum daily allowable travel distance is reached.

31. A computer program product coupled to a processor having computer readable program code embodied in the computer readable media for causing an application program to execute on a computer system method steps for assigning a plurality of job-sites to employees and for creating work schedules and routes to and from the job-sites, the employees using the routes to commute to the job-sites in order to work at the job-sites, comprising:
receiving job-site data including a list of job-sites, required tasks to be performed at the job-sites and job-site addresses;
determining the job-site coordinates from the job-site addresses;
receiving identity data including addresses of the employees;
determining the employee coordinates from the employee addresses;
receiving workload data of the employees, the workload data including the amount of time an individual employee is available to work;
determining distances between the employee coordinates and job-site coordinates;
assigning job-sites to the employees based on the distances and the workload data;
determining work schedules of the employees including the number of assigned job-sites to visit based on the distances and the workload data;
determining routes to and from the job-sites for the employees based on the distances and the workload data.

32. The computer program product of claim 31 wherein the step of assigning a job-site to the employees further comprises:
identifying, for a particular job-site, the closest employee to the particular job-site, the closest employee being at the shortest distance from the particular job-site;
identifying, for the particular job-site, the next closest employee to the particular job-site, the next closest employee being at the next shortest distance from the particular job-site;
determining the difference in distance between the closest employee and the next closest employee with respect to the particular job-site;
if the difference in distance between the closest employee and the next closest employee is greater than a predetermined percentage, assigning the particular job-site to the closest employee;
if the difference in distance between the closest employee and the next closest employee is less than the predetermined percentage, not assigning the particular job-site.

33. The computer program product of claim 32 wherein the method steps further comprises allocating the un-assigned job-site by calculating the percentage of original work availability of the closest employee and the next closest employee, and assigning the job-site to the employee that has a higher percentage of original work availability.

34. The computer program product of claim 33 wherein the step of determining routes for the employees comprises:
creating a map displaying the coordinates of the job-sites assigned to a particular employee and the employee coordinates;
starting at a first angle, centered at the employee coordinate, incrementing the angle to locate and add job-sites to the route;
calculating total distance traveled originating from the employee coordinate as more job-sites are added to the route;
returning to the employee coordinates and completing the daily route when a maximum daily allowable travel distance is reached;
incrementing the angle to create additional daily routes for other days until all job-sites are routed by a first set of routes, wherein the first set of routes has a plurality of daily routes.

35. The computer program product of claim 34 wherein the step of determining routes for the employees further comprises incrementing the starting angle and repeating the steps of claim 33 to create a plurality of sets of routes, wherein each set of routes is generated using a different starting angle and wherein each set of routes has a plurality of daily routes.

36. The computer program product of claim 34 wherein the step of determining routes for the employees further comprises calculating the total distance associated with each set of routes, and selecting the set of routes having the least total distance.

37. The computer program product of claim 34 wherein the step of determining routes for the employees further comprises:
creating a map displaying the coordinates of the job-sites assigned to a particular employee and the employee coordinates;
selecting the job-site farthest from the employee coordinates;
building a daily route by adding job-sites closest to the previously selected job-site;
calculating total distance traveled originating from the employee coordinate as more job-sites are added to the route;
returning to the employee coordinates and completing the daily route when a maximum daily allowable travel distance is reached or all job-sites are assigned.

38. The computer program product of claim 37 wherein the step of determining routes further comprises creating additional daily routes by repeating the steps of claim 36 until all job-sites are assigned.

39. The computer program product of claim 38 wherein the step of determining routes further comprises calculating the total distance associated with the routes.

40. The computer program product of claim 38 wherein the step of determining routes further comprises comparing the total distance associated with the routes in claim 38 to the total distance associated with the routes in claim 33, and selecting the routes having a shorter total distance.
